(19) United States
(12) Patent Application Publication
(10) Pub. No.: US 2002/0070296 A1
(43) Pub. Date: Jun. 13, 2002

(54) Method of assembling a fuel injector

(76) Inventors: Robert B. Perry, Leicester, NY (US); Karl J. Haltiner JR., Fairport, NY (US); Michael Schneider, Rochester, NY (US)

Correspondence Address: JAECKLE FLEISCHMANN & MUGEL, LLP, 2nd Floor, 39 State Street, Rochester, NY, 14614-1310, US

(21) Appl. No.: 10/071,333

(22) Filed: Feb. 8, 2002

Related U.S. Application Data
(63) Continuation-in-part of application No. 09/661,230, filed on Sep. 13, 2000.

(51) Int. Cl. B21K 1/20; F02M 39/00

(52) U.S. Cl. 239/533.3; 29/890.124

(57) ABSTRACT

An improved method for partially assembling a fuel injector comprising the steps of providing a fixture for receiving a guide disk having a guide opening and a valve seat having a ball seat; inserting the guide disk and valve seat into the fixture; providing a locating tool including a locating ball; extending the locating ball through the guide opening and seating the ball into the ball seat to displace the guide disk and valve seat into coaxial alignment with the locating tool, thereby aligning the opening of the guide disk with the ball seat of the valve seat; loading the valve seat and guide disk axially against a receiving surface of the fixture; welding the valve seat to the guide disk to form a coaxially-aligned valve seat and guide disk sub-assembly; removing the sub-assembly from the fixture; inserting the sub-assembly into a recess in a fuel injector valve body; and crimping an edge of the recess to retain the sub-assembly in the recess. The sub-assembly may be tested for coaxiality of the valve seat and guide disk or may be otherwise qualified as desired prior to insertion into the fuel injector valve body.

### RELATIONSHIP TO OTHER APPLICATIONS AND PATENTS

This application is a Continuation-In-Part of a pending and allowed U.S. patent application Ser. No. 09/661,230, filed Sep. 13, 2000.

### TECHNICAL FIELD

The present invention relates to fuel injectors; more particularly, to methods for assembling fuel injectors from components so that critical elements are coaxially aligned; and most particularly, to a method and apparatus for assembling a fuel injector from components wherein a valve seal and valve guide are aligned and joined in an off-line process to form a sub-assembly for later inclusion in fuel injector final assembly.

### BACKGROUND OF THE INVENTION

It is known in the art relating to solenoid-actuated engine fuel injectors to provide an armature fixed to a valve ball to function as a solenoid-actuated valve element. The valve ball is seatable on a valve seat and guided by a disk-shaped guide, the guide and valve seat being mounted in a recess of a valve body and being secured therein as by crimping an edge of the recess. The guide is provided to maintain the valve ball in close alignment with the valve seat when the valve is open so that uniform flow will be promoted around the ball and through the valve seat, and so that closure of the valve will require a minimum of sliding motion on the seat with a minimum of closing time. Typically, aligning the valve guide coaxially with the valve seat during assembly and crimping has involved excessively costly and complicated alignment methods.

For example, U.S. Pat. No. 5,625,946 issued May 6, 1997 to Wildeson et al. discloses a fuel injector having a valve body 16 with a bore 46 defining a fuel injector tube for supporting a tubular upper guide member 12 and, spaced apart from member 12, a lower guide member 48, valve seat member 30, orifice member 18, and seals 50. The upper and lower guide members are radially free to be positioned in their respective proper places. During assembly of the fuel injector, an alignment tool 52, which is essentially in the shape of the armature/valve member, is inserted through both the upper and lower guide members, and rests on and centers the valve seat member. The alignment tool thus coaxially aligns the valve seat member and thus also coaxially aligns the upper and lower guide members. The valve seat member is then secured to the valve body member by such means as forming the end of the valve body to press the lower guide member against a shoulder formed by a counterbore in the valve body member, thereby locking the lower guide member in place coaxially with the valve seat member. The upper guide member is secured to the fuel injector tube as by welding, the alignment tool is removed, and the actual armature/valve member is installed through the upper and lower guide members.

This assembly method can be time-consuming, cumbersome, and expensive. It requires both the insertion and the removal of an alignment fixture shaped like the armature/valve member, and the subsequent insertion of an actual armature/valve member, which double operation is consumptive of production-line time, reducing efficiency and throughput. Further, such double insertion increases the risk of damage to delicate elements such as the injector tube, which damage may not be obvious until the injector is subsequently installed in an engine. Still further, the success of coaxial alignment of the valve seat and valve guide cannot readily be tested until the fuel injector is fully assembled; faulty alignment results in costly rejection of all the injector components and waste of assembly time.

Therefore, there is a strong need for an improved method of assembling a fuel injector which does not require insertion of a foreign object into the injector tube and wherein the coaxiality of a valve seat and valve guide can be established, fixed, and confirmed by testing, in an off-line pre-assembly process prior to being incorporated into the fuel injector during final assembly.

It is a principal object of this invention to provide an improved assembly method for a fuel injector wherein the coaxiality of a valve seat and valve guide can be established, fixed, and confirmed by testing, in an off-line pre-assembly process prior to being incorporated into the fuel injector during final assembly.

It is a further object of this invention to provide an improved method for assembling a fuel injector whereby assembly line throughput is increased, and whereby waste and unit manufacturing costs are reduced.

### SUMMARY OF THE INVENTION

Briefly described, the present invention is directed to an improved method for assembling a fuel injector comprising the steps of:

a) providing a fixture for receiving a guide disk having a guide opening and a juxtaposed valve seat having a ball seat;

b) inserting the guide disk and valve seat into the fixture, the disk and seat being radially free;

c) providing a locating tool including a locating ball, the locating ball being preferably larger in diameter than a valve ball to be provided subsequently for inclusion in the fuel injector assembly;

d) extending the locating ball through the guide opening and seating the ball into the ball seat to radially displace the guide disk and/or the valve seat into coaxial alignment with the locating tool, thereby aligning the opening of the guide disk with the ball seat of the valve seat;

e) loading the valve seat and guide disk axially against a receiving surface of the fixture;

f) immovably fixing the valve seat to the guide disk as by tack welding to form a coaxially-aligned valve seat and guide disk sub-assembly;

g) removing the sub-assembly from the fixture;

h) inserting the sub-assembly into a recess in a fuel injector valve body; and

i) crimping an edge of the recess to retain the sub-assembly in the recess.

The sub-assembly may be tested for coaxiality of the valve seat and guide disk or may be otherwise qualified as desired prior to insertion into the fuel injector valve body. Preferably, the partially-assembled fuel injector includes an armature carrying a ball valve at the time the sub-assembly is inserted into the valve body, such that the sub-assembly is automatically positioned coaxially with the ball valve and armature by centering contact with the ball valve.

### BRIEF DESCRIPTION OF THE DRAWINGS

The foregoing and other objects, features, and advantages of the invention, as well as presently preferred embodiments thereof, will become more apparent from a reading of the following description in connection with the accompanying drawings in which:

FIG. 1 is a cross-sectional view of an engine fuel injector assembled in part by a method in accordance with the invention; and

FIG. 2 is a cross-sectional view showing forming of a sub-assembly by aligning and fixing a valve seat and valve guide disk prior to assembly into the fuel injector shown in FIG. 1.

### DESCRIPTION OF THE PREFERRED EMBODIMENT

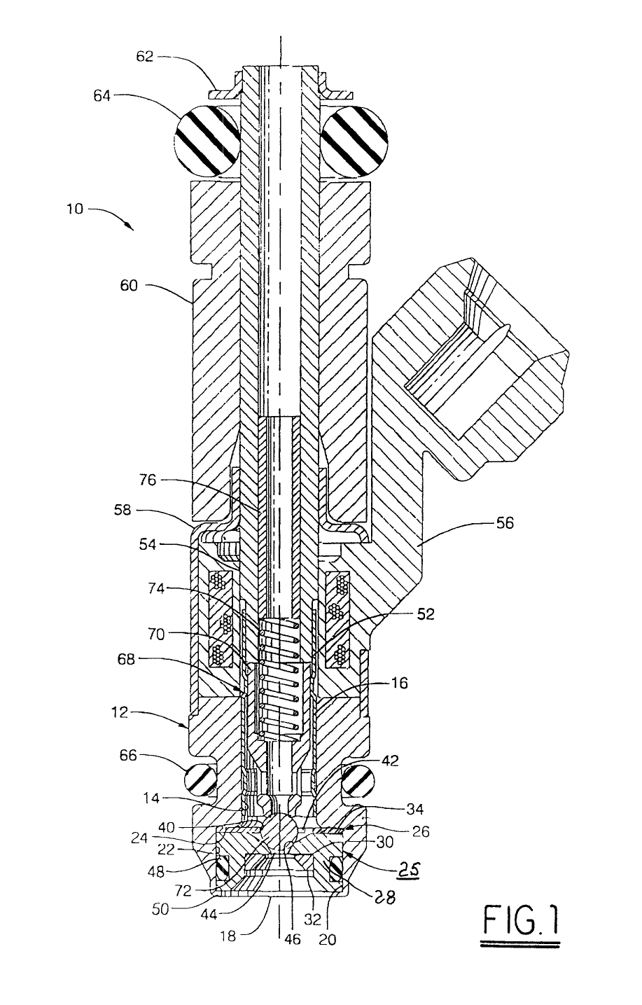

Referring to FIG. 1, numeral 10 generally indicates a solenoid-actuated plunger-type ball valve fuel injector capable of being partially assembled by a method in accordance with the present invention. Said fuel injector is useful, for example, for injecting fuel by repeating pulses into an internal combustion engine. Injector 10 includes a valve body 12 having a through passage 14 with inlet 16 and outlet 18 ends. Outlet end 18 includes an enlarged counterbore shaped recess 20 having a cylindrical inner surface 22 and a flat annular end surface 24.

Within recess 20 are received a unitized sub-assembly 25 comprising guide means 26, preferably a guide disk, and a valve seat 28 coaxially disposed and fixedly related as described hereinbelow. Recess 20 also carries a distributor plate 30 and retainer 32. Assembly 25 is loosely received within cylindrical surface 22 and has a flat upper side 34 engaging end surface 24. A central guide opening 40 is provided in the guide disk surrounded by several fuel conducting openings 42 spaced around the guide opening.

Valve seat 28 has a central passage 44 surrounded on an upper side by seat means 46, preferably a circular ball seat of any suitable shape, such as conical or curved sided. Below passage 44, director plate 30 is held in a lower recess by retainer 32. Seal ring 48 prevents fuel leakage around sub-assembly 25 which is retained in recess 20 by a crimped lower edge 50 at the outlet end 18 of valve body 12.

A tubular upper guide 52 is brazed in the inlet end 16 of the valve body passage 14 and extends upward to a sealing connection with a fuel tube 54, which also acts as a magnetic pole and valve stop. A coil assembly 56 is mounted around the fuel tube and upper guide and is held in place by an outer strap 58 welded at opposite ends to the fuel tube 54 and the valve body 12. A spacer 60 is positioned above the strap 58 and cooperates with an end ring 62 to retain a seal ring 64. A groove around the valve body also retains a lower seal ring 66.

A reciprocable valve member 68 is located within passage 14 of valve body 12. Member 68 includes a hollow armature 70 guided by the upper guide 52 and carrying at its lower end a valve head, preferably a ball 72, that extends into and is guided by the guide opening 40 of the guide disk 26. A spring 74 in the armature 70 is compressed by a calibration tube 76 pressed into the fuel tube 54 to provide a set biasing force urging valve ball 72 against ball seat 46. A small gap between valve armature 70 and the lower end of the fuel tube (magnetic pole) 54 allows the valve to be opened a set amount, typically about 100 μm, when the coil is energized, drawing valve member 68 upward against the valve stop (tube 54).

Guide opening 40 in guide disk 26 centers valve ball 72 when the valve is open and guides the ball to its seat 46 when the valve is closed. Thus, it is important that the central opening 40 of disk 26 be coaxially aligned with ball seat 46 of valve seat 28. The present invention provides a method of assembling the components within valve body 12 which assures that such alignment is accomplished and maintained in operation.

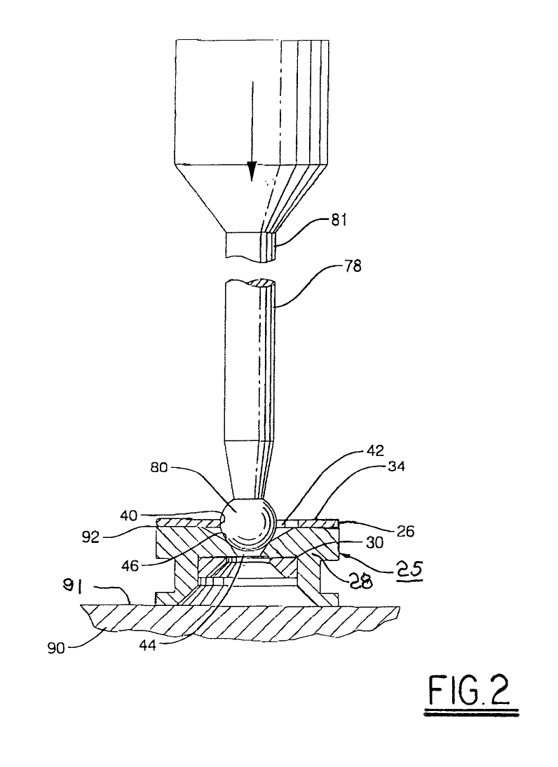

Referring to FIG. 2, a key step in a method of assembling a fuel injector in accordance with the invention is the formation of a fixed coaxial sub-assembly 25 comprising a guide disk and a valve seat. Preferably the sub-assembly is formed ahead of the general fuel injector assembly and off-line therefrom, such that the completed sub-assembly may be tested or otherwise qualified as needed prior to being incorporated into a fuel cell assembly.

As shown, valve seat 28 is placed on a receiving surface 91 of a holding fixture 90 with guide disk 26 disposed on the upper surface 38 of valve seat 28. A locating tool 78 for centering guide disk 26 on valve seat 28 is provided and includes an oversize ball 80 mounted on the end of a loading rod 81. Ball 80 is sized to fit closely with minimal clearance within central opening 40 of guide disk 26. The oversize ball 80 is inserted into the central guide opening 40, engaging ball seat 46, thereby aligning the disk opening with the ball seat. With ball 80 in place, disk 26 is then tack welded, as at 92, or otherwise fixed to valve seat 28, forming sub-assembly 25 wherein the guide disk and ball seat are coaxially prealigned. After removal from fixture 90, sub-assembly 25 is now ready for insertion into a recess 20 against surface 24, along with seal ring 48, wherein it is retained by crimping of edge 50 as described hereinabove, as a unitized component in the general assembly of fuel injector 10. Director plate 30 and retainer 32 may be installed into the lower recess in seat 28 either before or after formation of sub-assembly 25, as desired. Preferably, armature 70 carrying valve ball 72 is installed into passage 14 prior to insertion of sub-assembly 25 into recess 20, so that valve ball 72 engages ball seat 46 and thereby coaxially centers sub-assembly 25 with armature 70 in passage 14, assuring accurate closing of the valve by the ball in operation, with minimal sliding motion on the seat and with minimum closing time.

While the invention has been described with reference to preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention. Therefore, it is intended that the invention not be limited to the particular embodiments disclosed as the best mode contemplated for carrying out this invention, but that the invention include all embodiments falling within the scope and spirit of the appended claims.

What is claimed is:

1. A method for partially assembling a fuel injector, the fully assembled fuel injector having valve head means reciprocable through valve head guide means disposed in a valve body to mate with valve seat means also disposed in the valve body, the guide means having a first central opening and the seat means having a second central opening, comprising the steps of:
a) providing a fixture outside of said valve body;
b) providing an alignment tool having a simulated valve head means;
C) disposing said guide means and said seat means together in said fixture;
d) inserting said simulated valve head means through said first central opening and into said second central opening to coaxially align said first and second central openings;
e} fixedly attaching said guide means to said seat means to form a unitized sub-assembly;
f) withdrawing said simulated valve head means from said sub-assembly; and
g) removing said sub-assembly from said fixture.

2. A method in accordance with claim 1 wherein said valve body has a recess, and comprising the further steps of:
a) inserting said sub-assembly into said recess against said flat end surface; and
b) retaining said sub-assembly in said recess.

3. A method in accordance with claim 1 wherein said simulated valve head means includes a ball having a diameter greater than the diameter of said valve head means.

4. A method in accordance with claim 3 wherein said ball is close-fitting in said first central opening.

5. A method in accordance with claim 1 wherein said guide means is a disk.

6. A method in accordance with claim 1 wherein said valve seat means includes a ball seat surrounding said second central opening.

7. A method in accordance with claim 1 wherein said fixing step includes spot welding.

8. A method in accordance with claim 2 wherein said recess has an edge and a flat end surface, and wherein said retaining step includes crimping said edge to urge said sub-assembly against said flat end surface.

9. A fuel injector having a valve body and comprising a unitized sub-assembly including a valve guide means and a valve seat, said sub-assembly having been formed outside of said valve body and being retained within said valve body.

10. A fuel injector in accordance with claim 9 wherein said valve guide means and said valve seat in said unitized sub-assembly are coaxially aligned.

11. An internal combustion engine comprising a fuel injector having a valve body and a unitized sub-assembly including a valve guide means and a valve seat, said sub-assembly having been formed outside of said valve body and being retained within said valve body.
